(19) United States
(12) Patent Application Publication
(10) Pub. No.: US 2012/0178606 A1
(43) Pub. Date: Jul. 12, 2012

(54) Methods of Applying Barrier Edge Strips and Associated Systems and Constructs

(75) Inventors: Joseph C. Walsh, Boulder, CO (US); Norman L. Jesch, Golden, CO (US)

(73) Assignee: GRAPHIC PACKAGING INTERNATIONAL, INC., Marietta, GA (US)

(21) Appl. No.: 13/344,275

(22) Filed: Jan. 5, 2012

Related U.S. Application Data
(60) Provisional application No. 61/460,690, filed on Jan. 6, 2011.

(51) Int. Cl. B31B 1/26

(52) U.S. Cl. 493/405

(57) ABSTRACT

Blanks are conveyed in series, in a machine direction. Each blank comprises an edge that extends in the machine direction during the conveying, and opposite surfaces that extend to the edge. The edges of the blanks are covered with respective elongate barrier strips, comprising serially mounting the barrier strips respectively to the blanks during the conveying.

### CROSS-REFERENCE TO RELATED APPLICATION

This application claims the benefit of U.S. Provisional Patent Application No. 61/460,690, which was filed on Jan. 6, 2011. The entire disclosure of U.S. Provisional Patent Application No. 61/460,690, which was filed on Jan. 6, 2011, is incorporated herein by reference.

### BACKGROUND

Packages that are for containing greasy or oily foods, beverages or other liquids may be formed from paperboard blanks that include one or more barrier layers. The barrier layers may be applied to a sheet of paperboard before the blanks are cut from the composite sheet. As a result, in packages formed from the blanks, cut edges of the blanks may be exposed to the contents within the interior of the packages, and the paperboard fibers at the cut edges may absorb some of the contents in the interior of the packages. That is, it is typical for the internal lap seam edge of a package to be exposed to the contents in the package, and for any unprotected paperboard fibers at the internal lap seam edge to absorb some of the contents in the interior of the package. Such absorption may result in staining of the packaging material and/or impair the structural integrity of the package.

### BRIEF SUMMARY

In accordance with one aspect of this disclosure, a construct, such as a canister or other package, comprises a body, and the body comprises a composite sheet extending around an interior space of the construct. The composite sheet has opposite elongate ends that may extend perpendicularly relative to opposite ends of the body. The ends of the composite sheet are connected to one another at a lap seam, so that the ends of the composite sheet respectively are inner and outer ends of the composite sheet. The composite sheet comprises a layer of paperboard having an elongate inner edge extending along and at least partially defining the inner end of the composite sheet, and a barrier layer fixedly connected to and covering the inner surface of the paperboard for isolating the inner surface of the paperboard from the interior space of the construct. An elongate barrier strip extends along and is mounted to the inner end of the composite sheet for isolating the inner edge of the paperboard from the interior space of the construct.

One aspect of this disclosure is the provision of a method for processing blanks that comprise paperboard, wherein the method may comprise conveying the blanks in series, in a machine direction, and wherein each blank comprises an edge that extends in the machine direction during the conveying, and opposite surfaces that extend to the edge. The method may comprise covering the edges of the blanks with respective elongate barrier strips, comprising serially mounting the barrier strips respectively to the blanks during the conveying. For each blank and the respective barrier strip, a first elongate portion of the barrier strip is mounted to a marginal portion of the first surface of the blank, so that a second elongate portion of the barrier strip protrudes outwardly past the edge of the blank. Each of the marginal portion of first surface of the blank and the first and second portions of the barrier strip extend along the edge of the blank. The method may further comprise folding the second elongate portion of the barrier strip around the edge of the blank, and mounting the second elongate portion of the barrier strip to a marginal portion of the second surface of the blank, and this folding and mounting may also occur during the conveying. Adhesive material for facilitating the mounting of the barrier strips may be provided and/or activated in a variety of different manners. The method may further include forming each of the blanks into a construct, such as the type of construct described above.

An aspect of this disclosure is the provision of a system for processing blanks, wherein the system comprises a conveyor for conveying the blanks in series, so that for each blank, an edge of blank extends in the machine direction while the blank is being conveyed. The system further comprises a strip applicator for serially applying the barrier strips respectively to the blanks while the blanks are being conveyed by the conveyor, wherein for each blank and the respective barrier strip, the strip applicator mounts a first elongate portion of the barrier strip to a marginal portion of the blank that extends along the edge of the blank, so that the barrier strip extends along the edge of the blank and a second elongate portion of the barrier strip protrudes outwardly past the edge of the blank. The strip applicator may be characterized as an upstream mounting system, and optionally the upstream mounting system may further comprise any other features for providing and/or activating adhesive material for facilitating the mounting of the first elongate portion of the barrier strip to the marginal portion of the blank.

The overall system may further comprise a downstream mounting system positioned downstream from the upstream mounting system (e.g., the strip applicator) for further mounting the barrier strips respectively to the blanks. For each blank and the respective barrier strip, the secondary mounting apparatus folds the second elongate portion of the barrier strip around the edge of the blank, and mounts the second elongate portion of the barrier strip to a second marginal portion of the blank. The downstream mounting system may comprise a folding plow and optionally any other features for providing and/or activating adhesive material for facilitating the mounting of the second elongate portion of the barrier strip to the second marginal portion of the blank. The downstream mounting system may be positioned along the conveyor for folding and further mounting the barrier strips while the blanks are being conveyed by the conveyer. The overall system may comprise features for forming each of the blanks into a construct, such as the type of construct described above.

The foregoing presents a simplified summary of some aspects of this disclosure in order to provide a basic understanding. The foregoing summary is not an extensive summary of the disclosure and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of this disclosure in general terms, reference will now be made to the accompanying drawings, which are not necessarily drawn to scale and may be schematic. The drawings are exemplary only, and should not be construed as limiting the invention.

FIG. 1 is a pictorial view of a manufacturing line for forming canisters, wherein a system for applying barrier strips to edges of blanks is positioned between a system for supplying the blanks and a system for forming the blanks into canisters, in accordance with a first embodiment of this disclosure.

FIG. 2 is a top plan view of the system of FIG. 1.

FIG. 3 is a side elevation view of the system of FIG. 1.

FIG. 4 is an enlarged view of a portion of FIG. 1.

FIG. 5 is an enlarged view of a portion of FIG. 2.

FIG. 6 is an end elevation view of a representative blank with a first marginal portion of a respective barrier strip mounted to an upper marginal portion of the blank, and a second marginal portion of the barrier strip extending outwardly from the blank, in accordance with the first embodiment.

FIG. 7 is like FIG. 6, except that the barrier strip is folded around an edge of the blank, and the second marginal portion of the barrier strip is mounted to a lower marginal portion of the blank, so that the barrier strip is mounted to the edge of the blank, in accordance with the first embodiment.

FIG. 8 is a partial, top pictorial view of the barrier strip mounted to the edge of the blank, in accordance with the first embodiment.

FIG. 9 is similar to FIG. 8, except, for example, for being a bottom, exploded view, in accordance with the first embodiment.

FIG. 10 is a pictorial view of a canister, with a bottom wall and a lid exploded away from the opposite ends of the body of the canister, in accordance with the first embodiment.

FIG. 11 is a cross-sectional view of a portion of the body of the canister, wherein the cross-section is taken along line 11-11 of FIG. 10, in accordance with the first embodiment.

FIG. 12 is a pictorial view of a system in accordance with a second embodiment, wherein a system for applying barrier strips to edges of blanks is positioned between a system for supplying the blanks and a system for receiving/delivering the blanks.

FIG. 13 is a top plan view of the system of FIG. 12.

FIG. 14 is a side elevation view of the system of FIG. 12.

FIG. 15 is an enlarged view of a portion of FIG. 12.

FIG. 16 is an enlarged cross-sectional view of a portion of FIG. 13 taken along line 16-16 of FIG. 13.

FIG. 17 is an enlarged view of a portion of FIG. 13.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

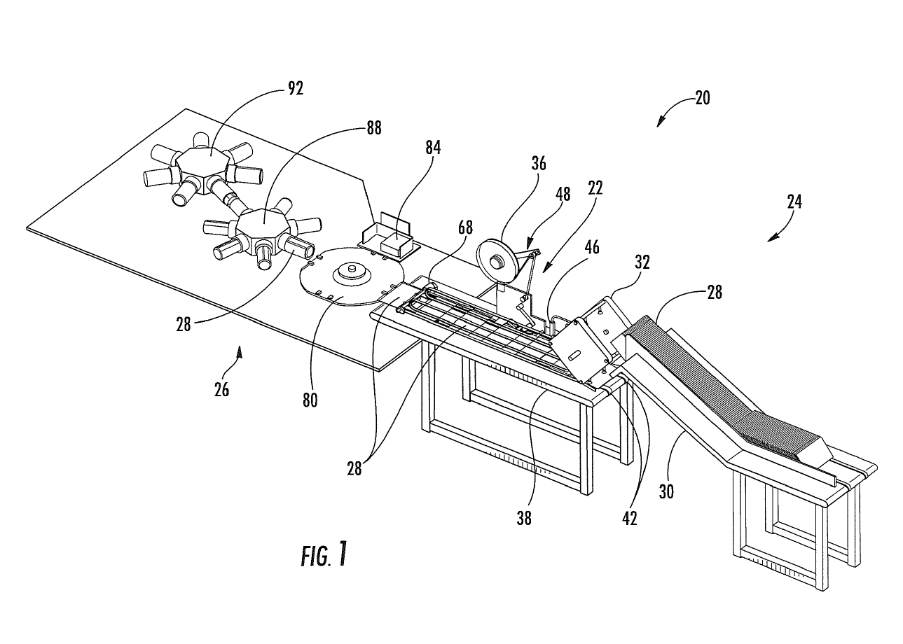

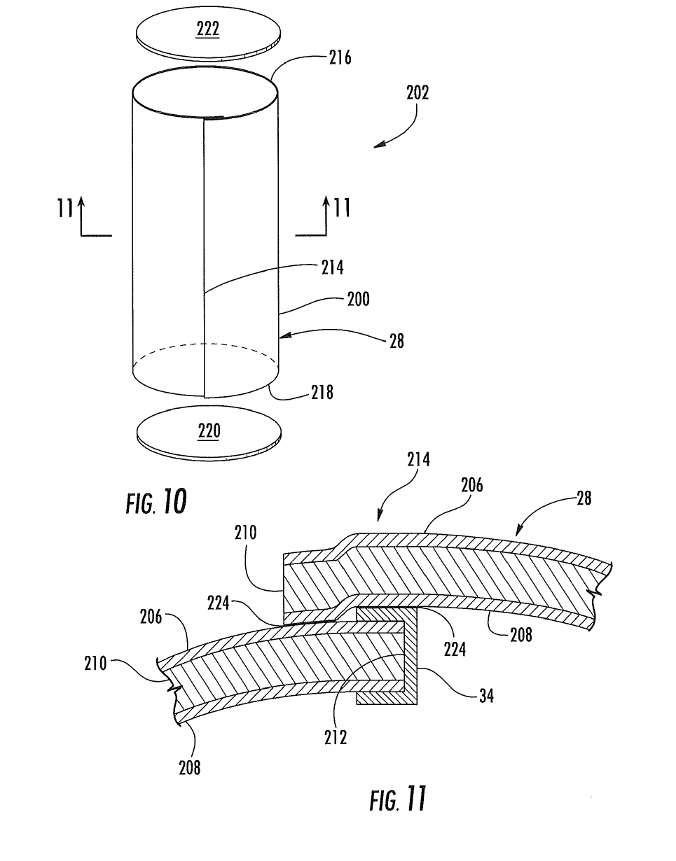

A first embodiment of a system of this disclosure is shown in FIGS. 1-5. As best understood with reference to FIGS. 1-3, a manufacturing line 20 of the first embodiment includes an edge protecting system 22 that is positioned directly between an upstream supplying system 24 and a downstream forming system 26. Generally described, the manufacturing line 20 is for making constructs from blanks 28. The constructs may be packages or portions of packages (e.g., substantially cylindrical canisters, cups, or erected trays, cartons, sleeves or any other suitable constructs) that are for containing a wide variety of contents such as, but not limited to, greasy or oily foods, beverages or other liquids. The constructs typically provide, or at least partially provide, barrier functions for protecting the constructs and/or the contents therein. In accordance with the first embodiment the constructs are canisters (e.g., see canister 202 in FIG. 10), although a wide variety of other types of constructs are within the scope of this disclosure.

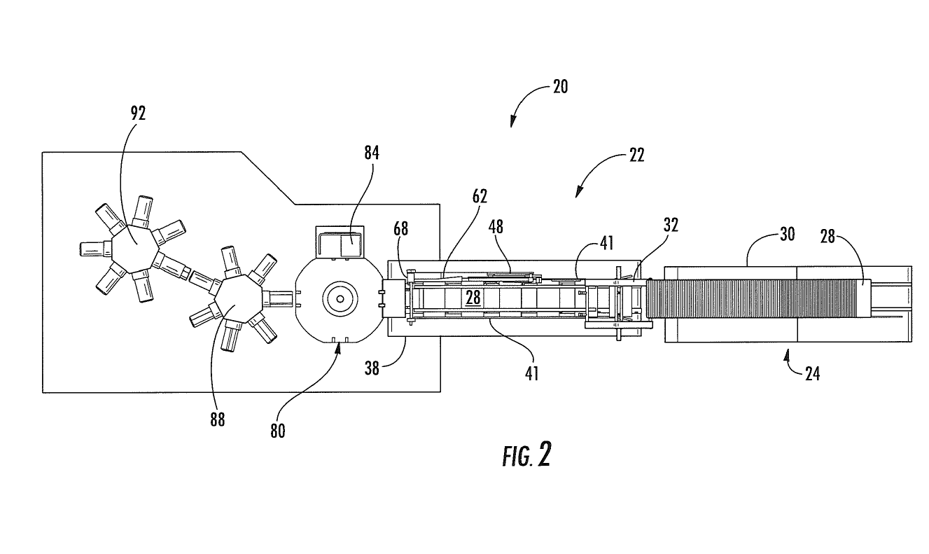

Referring to FIGS. 1 and 2, the supplying system 24 is for supplying the blanks 28 directly to the edge protecting system 22. The supplying system 24 may be any suitable system, such as a conventional system. For example, the supplying system 24 may include a feeder 30 for feeding the blanks 28 to a placer 32 that serially provides the blanks directly to the edge protecting system 22. The feeder 30 may be a conventional feed table and the placer 32 may be a conventional rotary placer. Suitable feed tables and rotary placers may be available from Paper Machinery Corporation (“PMC”) of Milwaukee, Wis., or from other suitable sources.

The constructs manufactured on the manufacturing line 20 typically provide, or at least partially provide, their barrier function by virtue of one or both of the opposite broad surfaces of the blanks 28 being protected (e.g., coated and/or laminated) with one or more barrier layers. Accordingly, each barrier layer may comprise one or more layers. Suitable barrier layers include, but are not limited to, wax coating(s) and/or polymer film(s) (e.g., polyester film, polypropylene film, and/or any other suitable films, coatings, or the like). The blanks 28 may comprise paperboard to which the barrier layer(s) were applied prior to the cutting of the blanks from the larger sheet of paperboard, so that paperboard fibers are at least initially exposed at one or more of the cut edges of the blanks.

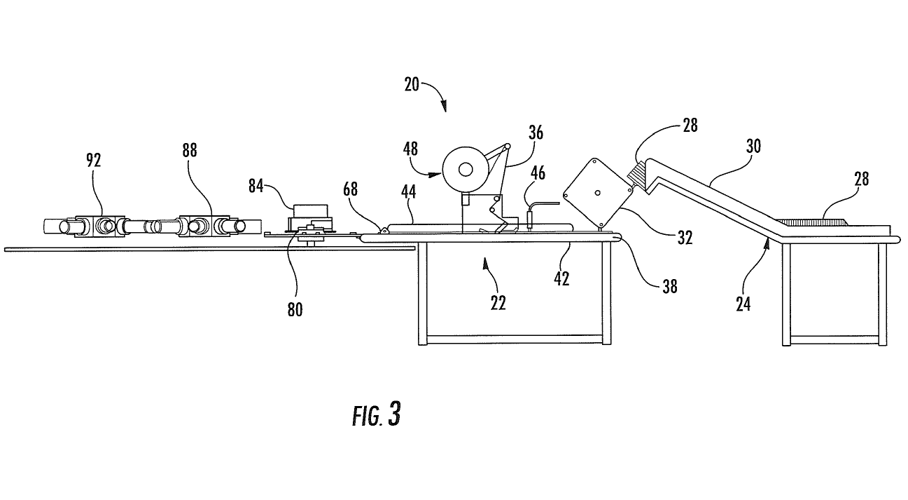

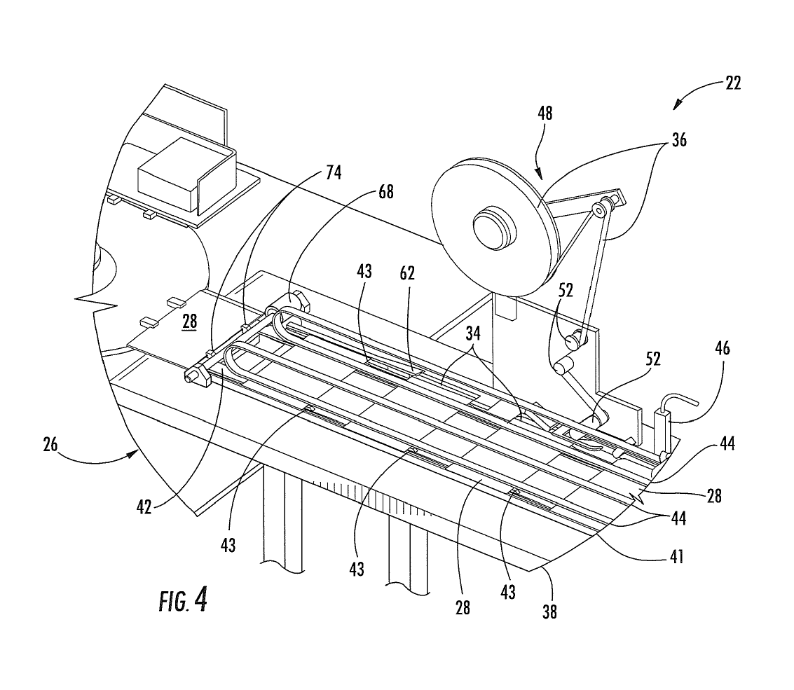

In this paragraph, operations of the edge protecting and forming systems 22, 26 will be very generally described. As best understood with reference to FIG. 4, the edge protecting system 22 covers cut edges of the blanks 28 with segments 34 cut from a strip 36 of barrier material (e.g., barrier edge tape). Thereafter, the forming system 26 (FIGS. 2-3) forms (e.g., shapes and/or erects and secures) the blanks 28 with strip-covered edges into the canisters. The forming system 26 forms the canisters with internal lap seams, so that the strip-covered edges of the blanks 28 are within the interior of the canisters, and so that the strip segments 34 (e.g., barrier strips) cover and protect (e.g., substantially isolate) the cut edges (e.g., at the lap seams) from the contents within the interior of the canisters. That is, the blanks' cut edges that are within the interior of the canisters are covered with the strip segments 34 so that those edges are sealed in a manner that seeks to prevent any exposure of the subject paperboard fibers to the contents in the interior of the canisters. The strip 36 may be a strip of any suitable barrier material, such as, but not limited to, a strip comprising polymer film(s) (e.g., polypropylene, polyester, olefin copolymers, polyethylene phthalate or any other suitable polymer strips). In accordance with a first version of the first embodiment, one side of the barrier strip 36 includes a pre-applied, pressure sensitive adhesive material.

With further reference to FIG. 4 and describing the edge protecting system 22 in greater detail, it has a frame with an upper support 38 (e.g., tabletop) having a length and width that extend in longitudinal and lateral directions, respectively. Other features of the edge protecting system 22, such as a conveyor, are mounted to the support 38. The conveyor may be any suitable type of conveyor or other transportation system. For example and referring also to FIG. 2, the conveyor may include laterally spaced apart side guides 41 (e.g., guide rails) that are mounted to and extend longitudinally upon the upper surface of the support 38. The placer 32 (FIGS. 1-3) serially places the blanks 28 between the upstream ends of the side guides 41, and then the conveyor transports the blanks longitudinally along the support 38.

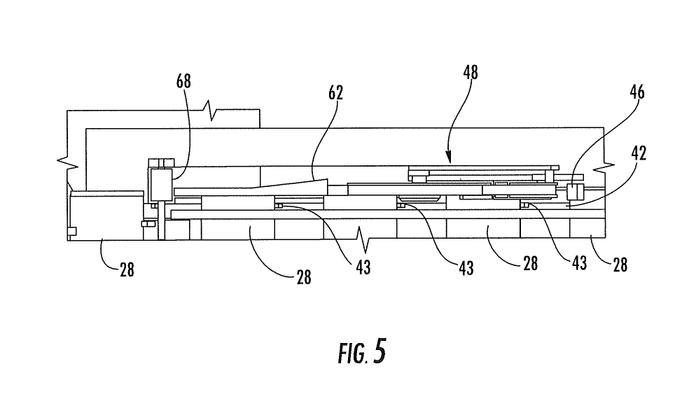

Referring to FIGS. 4 and 5, the conveyor includes longitudinally extending endless chains or endless lower conveyor belts 42 that are laterally spaced apart from one another. The lower conveyor belts 42 are positioned between the side guides 41 and below the blanks 28. The lower conveyor belts 42 are driven by a motor (e.g., via appropriate drive mechanisms) for urging the blanks 28 to travel in the downstream longitudinal direction upon/with the upper runs of the lower conveyor belts 42. Each of the lower conveyor belts 42 may extend completely around the support 38, or the lower conveyor belts may be arranged in any other suitable manner. The supplying system 22 places the blanks 28 upon the upper runs of the lower conveyor belts 42 at the upstream end of the edge protecting system 22.

Each of the lower conveyor belts 42 carries lugs 43 that are fixedly connected to the lower conveyor belts. The lugs 43 are arranged in a predetermined spacing for engaging the upstream edges of the blanks 28 in a manner that causes the blanks to move downstream with predetermined spacing between adjacent blanks. The supplying system 22 places the blanks 28 upon the lower conveyor belts 42 at the upstream end of the edge protecting system 22 so that, for each of the lower conveyor belts 42, each blank 28 is positioned between a respective pair of adjacent lugs 43.

The conveyor may further include a pair of upper conveyor belts 44 so that the blanks 28 are nipped (e.g., loosely nipped) between the lower and upper conveyor belts 42, 44. The conveyor belts 42, 44 extend around appropriate features (not shown), such as pulleys, rollers, or the like, so that the belts may travel in a conveyor-belt like fashion, and the upper conveyor belts may also be driven (e.g., by way of motor(s) and other appropriate drive mechanisms).

From the perspective of FIG. 4 and also referring to FIG. 5, the longitudinally extending, farthest away edges and upper and lower marginal surfaces of the blanks 28 extend in a cantilever-like fashion laterally beyond the farthest away lower conveyor belt 42. Optionally (e.g., if the barrier strip 36 does not include an adhesive backing), one or more adhesive applicators 46 may be positioned for depositing adhesive material onto the longitudinally extending, farthest away upper and lower marginal surfaces of the blanks 28. The adhesive applicators 46 may be any suitable adhesive applicators such as, but not limited to, adhesive applicator guns, printers, rollers, or the like.

The edge protecting system 22 includes a strip applicator 48 that is mounted to and supported by the support 38 at a position typically downstream from any upper adhesive applicator 46 (FIGS. 1, 3 and 4). The strip applicator 48 includes or is otherwise associated with a strip cutter (e.g., a knife edge) for cutting the barrier strip 36 into segments 34. Referring to FIG. 4, the strip applicator 48 is for attaching the strip segments 34 to the longitudinally extending, farthest away upper marginal surfaces of the blanks 28. The strip applicator 48 includes a frame that is mounted to the support 38. The frame of the strip applicator 48 rotatably supports a supply roll of the barrier strip 36, and also supports a series of other rotatably mounted rollers 52 (e.g., pulleys) that the barrier strip extends partially around on its path to the strip cutter and blanks 28. The strip applicator 48 may be any suitable strip applicator, such as, but not limited to, a conventional tape applicator. In accordance with one aspect of the first embodiment, the supplying and forming systems 24, 26 are parts of a conventional canister-forming manufacturing line (e.g., from Paper Machinery Corporation (“PMC”) of Milwaukee, Wis.) that have been separated from one another, and the strip applicator 48 is a conventional, intermittent motion, cut-to-length tape applicator that has been positioned between the separated supplying and forming systems 24, 26. A suitable tape applicator 48 may be available from Straub Design Company of Minneapolis, Minn., or from other suitable sources.

Operation of the components of the edge protecting system 22 is coordinated so that the barrier strip 36 is automatically, serially cut into the segments 34 that are of substantially the same longitudinal length as the blanks 28, and so that the segments 34 are respectively arranged in registration with (e.g., aligned with), and adhered to, the longitudinally extending, farthest away upper marginal surfaces of the blanks 28 (e.g., see FIG. 4). For example, appropriately adapted controller(s) and/or sensor(s) may be cooperatively associated with one or more features of the edge protecting system 22 (e.g., the conveyor belts 42, 44, motor(s) for driving the conveyor belts, any adhesive applicator(s) 46, the strip applicator 48 and/or strip cutter) in a manner so that the barrier strip 36 is automatically, serially cut into the segments 34 that are of substantially the same longitudinal length as the blanks 28, and so that the segments 34 are respectively arranged in registration with (e.g., aligned with), and adhered to, the longitudinally extending, farthest away upper marginal surfaces of the blanks 28.

The edge protecting system 22 is operative so that, from the perspective of FIG. 4, after the strip segments 34 are initially adhered to the longitudinally extending, farthest away upper marginal surfaces of the blanks 28, laterally projecting portions of the strip segments 34 extend laterally beyond the longitudinally extending, farthest away edges of the blanks. As a result, the longitudinally extending, farthest away edges of the blanks 28 are not yet enclosed by the strip segments 34.

The edge protecting system 22 further includes an edge folding apparatus, which may be referred to as a diverter 62 (e.g., a tape or strip folding plow), for enclosing the longitudinally extending, farthest away edges of the blanks 28 with the strip segments 34. The diverter 62 is mounted to and supported by the support 38 at a position downstream from the strip applicator 46. The diverter 62 is positioned in the path of the laterally projecting portions of the strip segments 34 so that there is sliding, face-to-face contact between the laterally projecting portions of the strip segments 34 and an engagement surface of the diverter as the blanks 28 are carried past the diverter by the conveyor. The engagement surface of the diverter 62 extends in the longitudinal direction and has a contour that varies in the longitudinal direction, so that the diverter folds the strip segments 34 around the longitudinally extending, farthest away edges of the blanks 28 as the blanks are carried past the diverter by the conveyor. As a result, the longitudinally extending, farthest away edges of the blanks 28 are substantially enclosed by the resulting somewhat, generally or substantially (sidewise oriented) U-shaped strip segments 34. That is and for each strip segment 34 and the respective blank 28, the longitudinally extending, opposite edges of the strip segment are respectively adhered to the longitudinally extending, farthest away upper and lower marginal surfaces of the blank.

The edge protecting system 22 may optionally further include a pair of nip rollers 68 that are positioned downstream from the diverter 62. The nip rollers 68 may be rotatably carried by member(s) mounted to the support 38. The nip rollers 68 may be operative for completing the formation of and/or additionally securing the at least generally (sidewise oriented) U-shaped strip segments 34 to the blanks 28. In this regard, the nip rollers 68 are arranged so that the longitudinally extending, farthest away edges of the blanks 28 pass tightly between (e.g., are nipped between) the nip rollers 68 while the blanks are carried past the nip rollers by the conveyor.

The edge protecting system 22 passes the blanks 28 to the forming system 26 as, or after, the blanks reach the downstream end of the conveyor. For example, the blanks 28 may be passed from the downstream end of the conveyor and/or from a shuttling apparatus 74 (FIG. 4), which is adjacent the downstream end of the conveyor, directly to the forming system 26. Any shuttling apparatus 74 may be a conventional servo-driven linear shuttle or any other suitable transporting mechanism for carrying out or aiding in the transferring of the blanks 28 from the edge protecting system 22 directly to the forming system 26.

The forming system 26 may be a conventional machine for forming the blanks 28 into containers such as, but not limited to, substantially cylindrical canisters. For example and referring to FIGS. 1-3, the conventional forming system 26 may include an upstream turret 80 for receiving the blanks 28 from the edge protecting system 22 and carrying the blanks past a heater 84. The heated blanks 28 may be transferred from the upstream turret 80 to an intermediate turret 88. The blanks 28 may be formed into the sidewalls of the canisters on the intermediate turret 88. The blanks may be transferred from the intermediate turret to a downstream turret 92. Rims of the canisters may be formed on the downstream turret 92. That is, after the strip segments 34 are fully applied onto the blanks 28 by the edge protecting system 22, a conventional forming system 26 may form the blanks with strip-protected edges into constructs that may more specifically be canisters. In this regard, a suitable machine for forming canisters may be available from Paper Machinery Corporation (“PMC”) of Milwaukee, Wis., or from other suitable sources. Alternatively and as alluded to above, the conventional forming system 26 for fabricating canisters may be replaced with a wide variety of other types of forming systems for forming the blanks 28, or other suitable blanks, into other constructs such as, but not limited to, cups, or erected trays, cartons or sleeves, or any other suitable constructs.

Operation of the systems 22, 24, 26 of the manufacturing line 20 are coordinated to facilitate the proper timing of the passing of the blanks 28 from the supplying system 24 downstream to the edge protecting system 22, and from the edge protecting system downstream to the forming system 26. For example, controller(s) and/or sensor(s) may be cooperative with the respective features of the manufacturing line 20 for coordinating the proper passing of the blanks 28 from the supplying system 24 downstream to the edge protecting system 22, and from the edge protecting system downstream to the forming system 26. In one example, the speed of operation of the edge protecting system 22 is matched to the speed of operation of the forming system 26, and the speed of operation of the supplying system 24 is matched to the speed of operation of the edge protecting system 22.

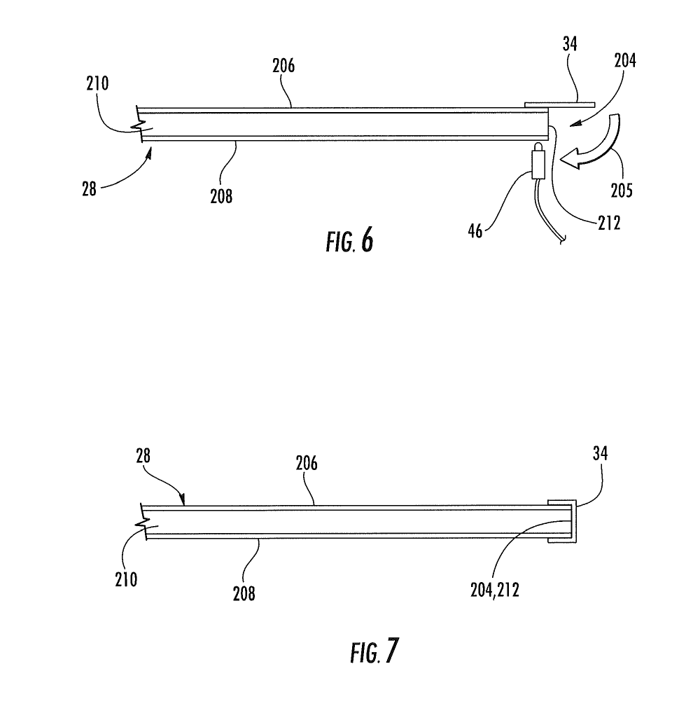

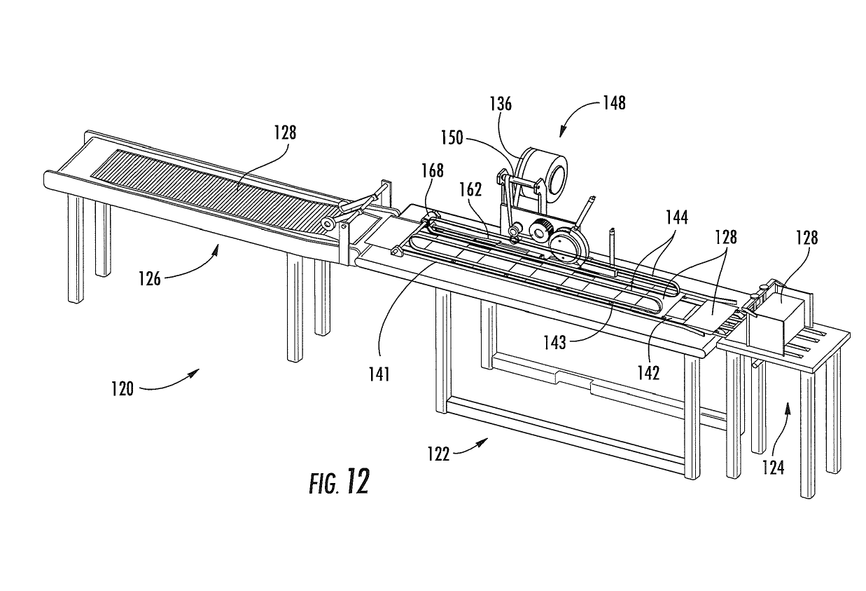

FIGS. 6-11 illustrate aspects of a representative blank 28 being processed by the manufacturing line 20 to form a construct, such as a cylindrical body 200 of the canister 202 shown in FIG. 11, in accordance with the first embodiment. Partially reiterating from above, the conveyor of the edge protecting system 22 conveys the blanks 28 in series, in a machine direction. For each blank 28, the edge 204 that gets covered by the respective elongate segment 34 of the strip 36 of barrier material extends in the machine direction during the conveying.

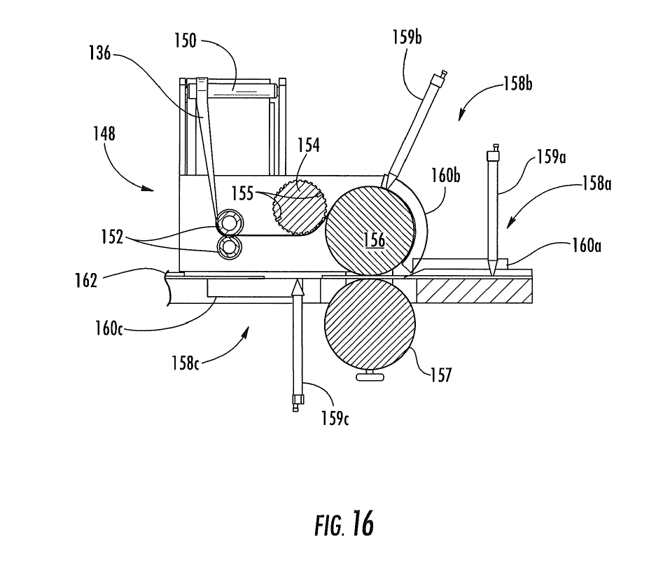

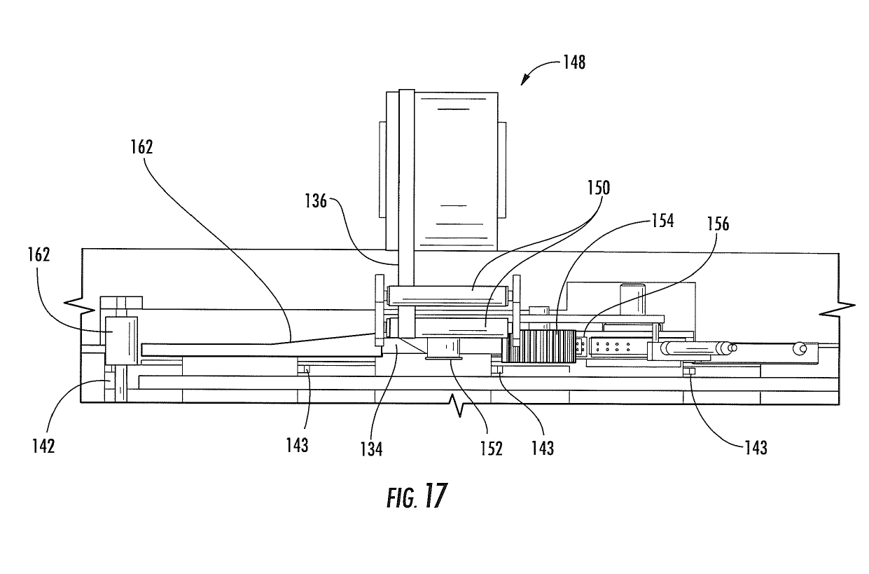

Referring to FIG. 6, for each blank 28, the strip applicator 48 applies a first elongate portion of the strip segment 34 (e.g., barrier strip) to a marginal portion of the upper surface of the blank, so that a second elongate portion of the strip segment protrudes outwardly past the edge 204 of the blank. The strip applicator 48 may be characterized as an upstream mounting system, and the upstream mounting system may optionally further comprise any other features for providing and/or activating adhesive material for facilitating the mounting of the first elongate portion of the barrier strip segment 34 to the respective marginal portion of the blank 28. For example, see the upstream adhesive applicator 46 shown in FIGS. 1, 3 and 4, and examples of upstream and intermediate adhesive activators/heat supplying apparatuses 158a, 158b (FIG. 16) are discussed below with reference to a second embodiment. Any other suitable features for providing and/or activating adhesive material may be used.

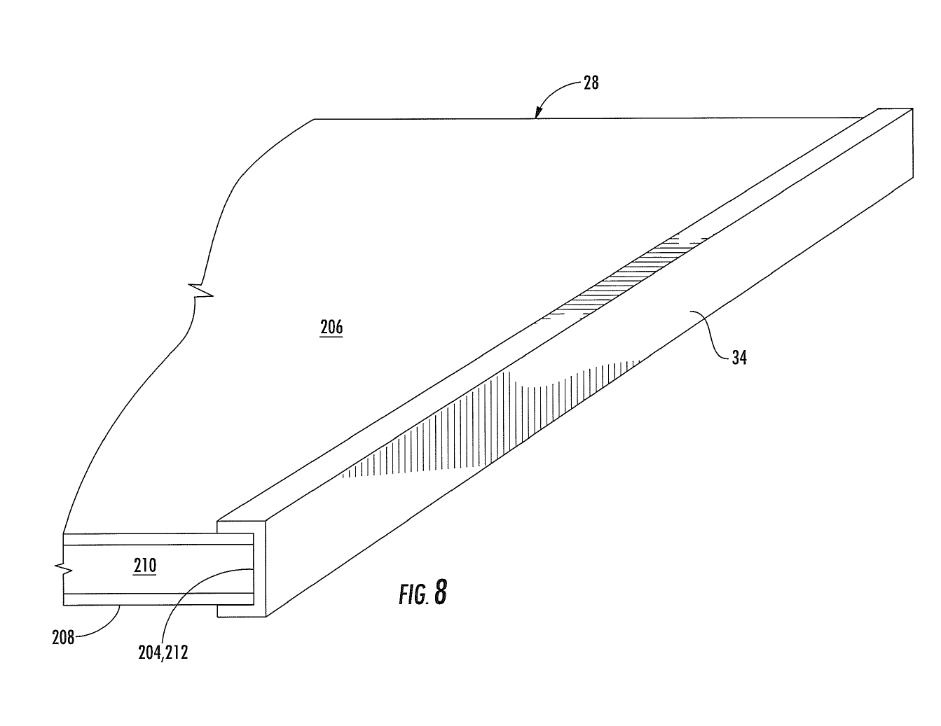

Referring to FIG. 7, the diverter 62 folds the second portion of the strip segment 34 around the edge 204 of the blank 28, and the second portion of the strip segment is mounted to a marginal portion of the lower surface of the blank, so that the barrier strip covers the edge of the blank. The folding of the second portion of the strip segment 34 around the edge 204 of the blank 28 is schematically illustrated by an arrow 205 in FIG. 6. The folding plow/diverter 62 may be characterized as a downstream mounting system, and the downstream mounting system may optionally further comprise any other features for providing and/or activating adhesive material for facilitating the mounting of the second elongate portion of the barrier strip segment 34 to the respective marginal portion of the blank 28. For example, see the downstream adhesive applicator 46 shown in FIG. 6, and an example of a downstream adhesive activator/heat supplying apparatuses 158c (FIG. 16) is discussed below with reference to the second embodiment. Any other suitable features for providing and/or activating adhesive material may be used.

As shown in FIGS. 6-9 and 11, the blank 28 of the first embodiment is a composite sheet, and the composite sheet has upper and lower barrier layers 206, 208 fixedly connected to and covering upper and lower surfaces of a piece of paperboard 210. Referring to FIG. 6, an elongate edge 212 of the paperboard 210 is initially exposed at the edge 204 of the blank 28. Referring to FIG. 7, after the strip segment 34 is mounted to the end of the blank 28, the elongate edge 212 of the paperboard 210 is covered by the strip segment 34. More specifically regarding the strip segment 34 being mounted to the end of the blank 28, elongate marginal portions of the strip segment are respectively mounted to elongate marginal portions of the barrier layers 206, 208. Each of the marginal portions of upper and lower surfaces of the blank 28 (e.g., the marginal portions of the upper and lower barrier layers 206, 208), the first and second portions (e.g., the marginal portions) of the strip segment 34, and the edge 212 of the paperboard extend in the machine direction along the edge 204 of the blank.

In the forming system 26, the heater 84 applies heat to both the end of the blank 28 to which the strip segment 34 is mounted, and the opposite end of the blank. While those ends are still hot, the blank 28 is wrapped around one of the mandrels on sidewall turret 88, so that the opposite ends of the blank are overlapped. Referring to FIGS. 10 and 11 and by way of conventional features of the forming system 26, the heated overlapping ends of the blank/composite sheet 28 are pressed against the mandrel to complete formation of a lap seam 214, and to thereby form the body 200 of the canister 202.

The body 200 comprises the composite sheet 28 and the lap seam 214. The body 200 has opposite top and bottom ends 216, 218. A round opening at the bottom end 218 may be closed with a round bottom wall 220 by way of conventional features of the forming system 26. A round opening at the top end 216 may be closed with a conventional removable, round lid 222. The composite sheet 28 extends around an interior space of the canister 202, and, in accordance with the first embodiment, the lap seam 214, and each of the opposite ends of the composite sheet that are part of the lap seam, extend perpendicularly relative to the opposite ends 216, 218 of the body 200.

Referring to FIG. 11, the ends of the composite sheet 28 respectively are inner and outer ends of the composite sheet, the barrier layers 206, 208 respectively are inner and outer barrier layers, and the marginal portions of the strip segment 34 respectively are inner and outer marginal portions of the strip segment. The inner barrier layer 208 is fixedly connected to and covers the inner surface of the paperboard 210 for isolating the inner surface of the paperboard from the interior space of the canister 202, and the strip segment 34 extends along and is mounted to the inner end of the composite sheet 28 for isolating the inner edge of the paperboard from the interior space of the canister, so that paperboard is protected from any contents in the canister and vise versa.

The opposite inner and outer ends of the composite sheet 28 are connected to one another by one or more elongate bonds 224 that are part of, and extend along, the lap seam 214. In the first embodiment, each of the barrier layers 206, 208 and the strip segment 34 are constructed of thermoplastic material, and as a result of the heater 84 applying heat to the opposite ends of the composite sheet 28, and the heated overlapping ends of the composite sheet 28 being pressed against the respective mandrel of the intermediate turret 88, both the inner barrier layer 206 and the outer marginal portion of the strip segment 34 fuse together, and the inner and outer barrier layers fuse together, to form the elongate bonds 224. That is, the barrier strip 36 and barrier layers 206, 208 may be constructed of, or comprise, heat-sealable poly material, or the like, for being thermally fused together to form the elongate bonds 224. The bonds 224 may be combined into a single bond, or one of the bonds 224 may be omitted. Alternatively, the one or more elongate bonds 224 may be formed through the use of any other suitable adhesive materials.

Whereas the canister 202 is described as having a cylindrical body 200 and other round features (e.g., top and bottom ends 216, 218), differently shaped canisters are within the scope of this disclosure. For example the canisters may be in any other suitable shapes, such as, but not limited to, frustoconical shapes, such as for being used as nestable canisters or cups.

In one aspect of this disclosure, the composite sheet 28 extends around an interior space of a construct, which may be in the form of the body 200 of the canister 202. The composite sheet 28 has opposite elongate ends extending perpendicularly relative to the opposite ends of the body 200, and the ends of the composite sheet are connected to one another at the lap seam 214, so that the ends of the composite sheet respectively are inner and outer ends of the composite sheet. The barrier strip 36 extends along and is mounted to the inner end of the composite sheet 28 for isolating the inner edge 212 of the paperboard 210 from the interior space of the canister 202. More specifically, the barrier strip 36 covers the inner edge 212 of the paperboard 210, and the barrier strip is positioned between the inner edge of the paperboard and the interior space of the canister 202.

Reiterating from above and in accordance with the first version of the first embodiment, one side of the barrier strip 36 includes a pre-applied, pressure sensitive adhesive material that is adapted for mounting the strip segments 34 to the edges of the blanks 28. In other versions, the adhering may be carried out in any suitable manner. For example and in accordance with a second version of the first embodiment, the barrier strip 36 does not include a pre-applied, pressure sensitive adhesive, and upper and lower adhesive applicators 46 are positioned for depositing adhesive material onto the longitudinally extending, farthest away upper and lower marginal surfaces of the blanks 28. The upper adhesive applicator 46 shown in FIGS. 1, 3 and 4 is for applying the adhesive material to the farthest away upper marginal surfaces of the blanks 28, and the lower adhesive applicator 46 shown in FIG. 6 is for applying the adhesive material to the farthest away lower marginal surfaces of the blanks 28. The upper adhesive applicator 46 is positioned downstream from the placer 32 and upstream from the strip applicator 48, and the lower adhesive application is positioned upstream from the folding plow/diverter 62.

In the second version of the first embodiment, the barrier strip 36 and the adhesive material applied by the applicators 46 would typically be selected for providing quick adhesion. For example, the adhesive material applied by the applicators may be a UV-curable adhesive material, a hot melt adhesive material, a dry-bond adhesive material and/or any other suitable adhesive material for allowing the folding of the strip segments 34 to be quickly and effectively carried out by the folding plow/diverter 62. Similarly, the respective side of the barrier strip 36 would typically be selected for being compatible with the adhesive materials, such as the fast-setting adhesive materials. For instance, if the barrier strip 36 is a poly material, it may be desirable for the inner surface of the barrier strip that is to be adhered around the edge of the blank 28 to be corona, plasma, or otherwise “treated” for enhancing the manner in which the inner surface of the strip segments 34 accept the adhesive material supplied from the applicators 46. Regarding the outer surface of the barrier strip 36, it will typically comprise heat-sealable poly material, or the like, for being thermally fused to the inner barrier layers 206 to at least partially form the elongate bond(s) 224 of the lap seam 214. Alternatively, the one or more elongate bonds 224 may be formed through the use of any other suitable adhesive materials.

In another version of the first embodiment, the mounting of the barrier strips 36 to the upper and/or lower margins of the blanks 28 may be facilitated by way of the barrier strip 36 comprising thermoplastic adhesive material (e.g., heat sealable and/or heat-activated adhesive material) that is heated at the appropriate time for facilitating the desired adhesion. More generally, the opposite marginal portions of the strip segments 34 may be mounted to the opposite marginal portions of the blanks 28 in any suitable manner, such as through the use of any suitable adhesive materials and techniques.

In accordance with one example of the first embodiment, the operational speed of the edge protecting system 22 is slowed down to match the full (e.g., maximum) operational speed of the forming system 26, and the operational speed of the supplying system 22 is adjusted to match the operational speed of the edge protecting system 22. Therefore, the speed of operation of the forming system 26 is not negatively impacted by the strip segments 34 being applied to the blanks 28.

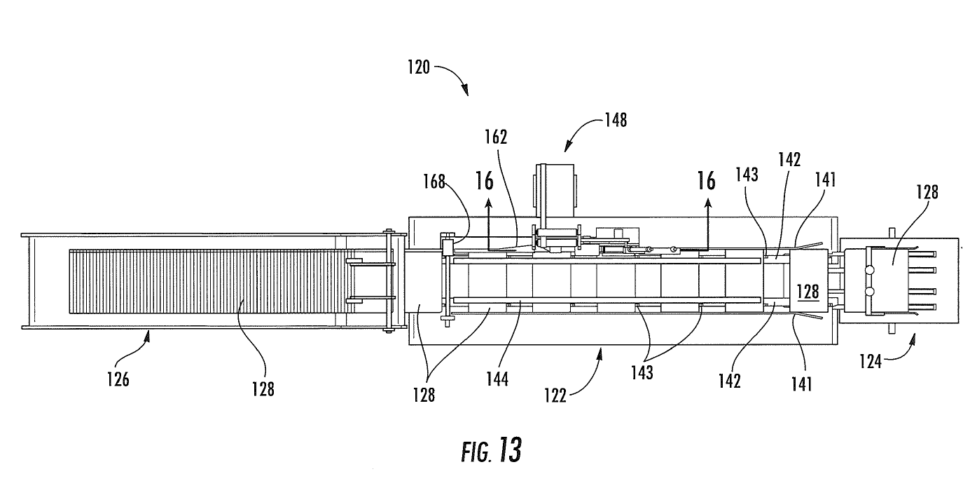

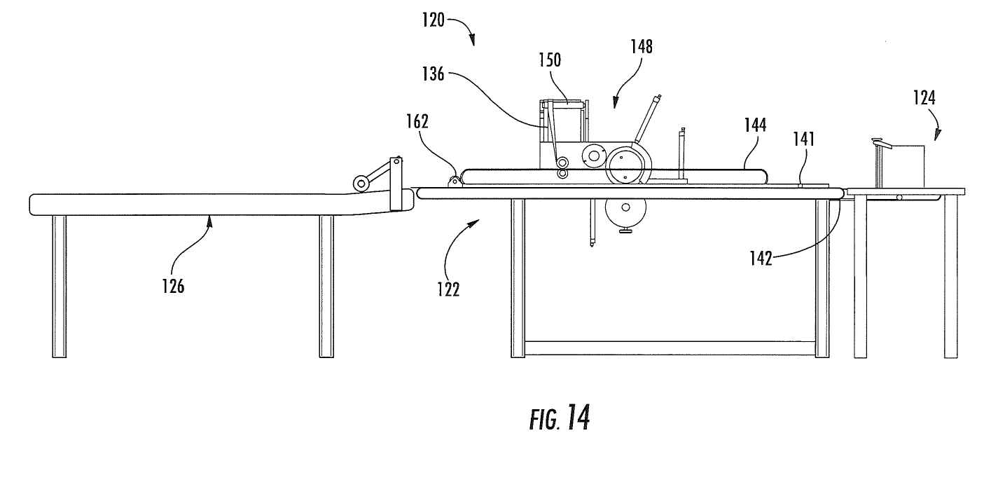

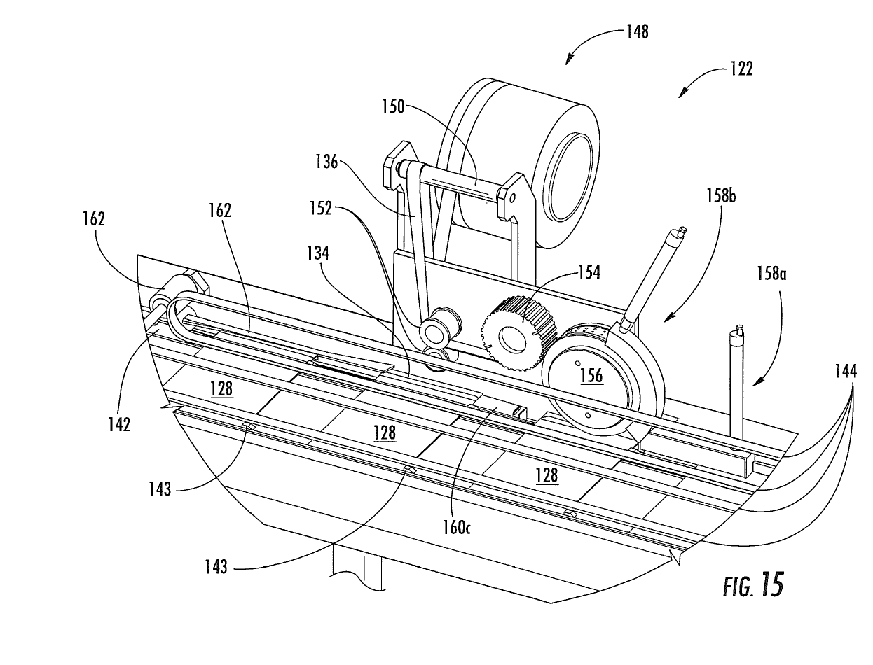

In accordance with one aspect of this disclosure, a edge protecting system 122 (FIGS. 12-17) of a second embodiment of this disclosure may be able to operate much more quickly than both the edge protecting system 22 of the first embodiment and the forming system 26 of the first embodiment. Therefore, in the following, the edge protecting system 122 of the second embodiment is initially described as being operated out of line with the forming system 26 of the first embodiment. Notwithstanding, a wide variety of different combinations of components and/or operational speeds are within the scope of this disclosure.

The second embodiment of this disclosure is like the first embodiment, except for variations noted and variations that will be apparent to one of ordinary skill in the art. Due to the similarity, components of the second embodiment that are identical and/or function in at least some ways similarly to corresponding components of the first embodiment have reference numbers incremented by one hundred.

Aspects of the second embodiment are shown in FIGS. 12-17 and discussed in the following. As best understood with reference to FIGS. 12-14, a manufacturing line 120 includes a edge protecting system 122 that is positioned directly between an upstream supplying system 124 and a downstream delivery conveyor system 126. The supplying system 124 is for supplying the blanks 128 directly to the edge protecting system 122. The supplying system 124 may be any suitable system, such as a conventional system. For example, the supplying system 124 may be a conventional, timed bump feed table, or any other suitable system, for serially placing the blanks 128 between the side guides 141 (e.g., guide rails) and upon the upper runs of the lower conveyor belts 142 at the upstream end of the edge protecting system 122. For each of the lower conveyor belts 142, each blank 128 is positioned between a respective pair of adjacent lugs 143. The upper conveyor belts 144 may assist with the conveying.

Referring to FIG. 15, the strip applicator 148 of the edge protecting system 122 is for applying segments 134 of the barrier strip 136 to the longitudinally extending, farthest away upper marginal surfaces of the blanks 128. In accordance with the second embodiment, the barrier strip 136 is drawn from a roll and is in the form of a continuous foil (aluminum foil) strip that is backed with heat sealable and/or heat-activated adhesive material. For example, the barrier strip 136 may be backed with a heat sealable polymer film, a heat sealable coating, a hot melt adhesive, or any other suitable material for causing adherence between the barrier strip and the blanks 128. More specifically and in accordance with the second embodiment, the barrier strip 136 is backed with a heat-activated adhesive material that is polyethylene.

Referring to FIGS. 15-17, the barrier strip 136 is drawn from its supply roll around turn bars 150, which have smooth surfaces. Thereafter, the barrier strip is nipped between a pair of rotatably mounted rollers 152. One of the rollers 152 (e.g., the lowest one shown in FIGS. 15 and 16) may be a motor-driven drive roller that is coated with rubber or another suitable material. The barrier strip 136 is supplied to a nip between a rotatably mounted cutter roll 154 and a rotatably mounted vacuum transfer roll 156. Each of the cutter roll 154 and the transfer roll 156 may be motor-driven. A pair of cutting blades 155 (FIG. 16) are mounted to and project outwardly from the outer circumferential surface of the cutter roll 154. The transfer roll 156 defines an inner chamber that is in fluid communication with a vacuum pump or another suitable air mover, so that air is drawn inwardly through numerous holes in the outer circumferential surface of the transfer roll 156.

The cutter roll 154 is configured and operated so that, by way of the cutting blades 155, the barrier strip 136 is automatically, serially cut into segments 134 that are of substantially the same longitudinal length as the blanks 128. The non adhesive-backed surfaces of the cut strip segments 134 are held against the outer circumferential surface of the transfer roll 156 by way of the partial vacuum supplied to the numerous holes in the outer circumferential surface of the transfer roll 156. As best understood with reference to FIG. 15, the transfer roll 156 is rotated in a coordinated manner so that the longitudinally extending, closest half of the strip segments 134 are respectively arranged in registration with (e.g., aligned with), and adhered to, the longitudinally extending, farthest away upper marginal surfaces of the blanks 128. That is, the barrier strip 136 is cut to length and applied to the blanks 128 with the vacuum transfer roll 156 which matches the speed/spacing of the blanks 128 on the conveyor.

As best understood with reference to FIG. 16, this adhering may be facilitated by nipping the respective portions of the strip segments 134 and blanks 128 between the transfer roll 156 and a rotatably mounted nip roll 157. An adjustment mechanism may be provided for adjusting the pressure applied by the nip roll 157/adjusting the size of the gap/nip between the transfer and nip rolls 156, 157.

As mentioned above, in accordance with the second embodiment the barrier strip 136 is backed with a heat-activatable adhesive material, and the heat-activatable adhesive material may be activated in any suitable manner. For example and as best understood with reference to FIG. 16, the edge protecting system 122 may include upstream, intermediate and downstream heat supplying apparatuses 158a, 158b, 158c for activating the heat-activatable adhesive material. In accordance with the second embodiment, each of the heat supplying apparatuses 158 includes a forced convection heater 159 and a shroud 160 or other suitable type of heat distributor that extends along and directs the hot air from the heater to the desired location(s). Each heater 159 may include (or heaters may share) a motor-operate air mover (e.g., a motor-driven fan or any other suitable device for moving air) that forces air across a heating coil (e.g., an electrical heating coil). Alternatively, each heater 159 may be any suitable apparatus (e.g., an infrared radiant heater) for causing the desired heat transfer.

From the perspective of FIG. 15 but also referring to FIG. 16, the heater 159a and shroud 160a of the upstream heat supplying apparatus 158a are configured to direct their heat against the longitudinally extending, farthest away upper marginal surfaces of the blanks 128 for preheating purposes. That is, the shroud 160a of the upstream heat supplying apparatus 158a is serially in opposing face-to-face relation with the longitudinally extending, farthest away upper marginal surfaces of the blanks 128 for preheating purposes. From the perspective of FIG. 15, the heater 159b and arcuately curved shroud 160b of the intermediate heat supplying apparatus 158b are configured to direct their heat against the longitudinally extending, closest half of the adhesive-backed side of each strip segment 134 as the strip segment is being carried past the intermediate heat supplying apparatus 158b by the transfer roll 156. That is, the arcuately curved shroud 160b of the intermediate heat supplying apparatus 158b is serially in opposing face-to-face relation with the longitudinally extending, closest half of the adhesive-backed side of the strip segments 134 carried by the transfer roll 156. From the perspective of FIG. 15, the heater 159c and shroud 160c of the downstream heat supplying apparatus 158c are configured to direct their heat against the longitudinally extending, farthest away half of the adhesive-backed side of the strip segments 134 and the farthest away lower marginal surfaces of the blanks 128. That is, the shroud 160c of the downstream heat supplying apparatus 158c is serially in opposing face-to-face relation with the longitudinally extending, farthest away half of the adhesive-backed side of the strip segments 134 and the farthest away lower marginal surfaces of the blanks 128. A variety of different types adhesive materials and methods of applying and/or activating the adhesive materials are within the scope of this disclosure.

The diverter 162 (e.g., a strip or tape folding plow) is positioned downstream from the downstream heat supplying apparatus 158c for folding the strip segments 134 around the longitudinally extending, farthest away edges of the blanks 128 as the blanks are carried past the diverter by the conveyor. As a result, the longitudinally extending, farthest away edges of the blanks 128 are substantially enclosed by the resulting somewhat, generally or substantially (sidewise oriented) U-shaped strip segments 134. That is and for each strip segment 134 and the respective blank 128, the longitudinally extending, opposite edges of the strip segment are respectively adhered to the longitudinally extending, farthest away upper and lower marginal surfaces of the blank. Optionally, the nip rollers 168 or other suitable mechanisms may complete the formation of and/or additionally secure the strip segments 134 to the edges of the blanks.

The edge protecting system 122 passes the blanks 128 directly to the downstream conveyor system 126 or directly to any other suitable system, such as a forming system (e.g., the forming system 26 of the first embodiment) for forming the blanks 128 into constructs. The downstream conveyor system 126 may be any suitable type of conventional conveyor for collecting and delivering the blanks 128.

Appropriately adapted controller(s) and/or sensor(s) may be cooperatively associated with one or more features of the edge protecting system 122 (e.g., the conveyor belts 142, 144 rolls 152, 154, 156 and/or motor(s) for driving respective components of the edge protecting system) in a manner so that the barrier strip 136 is automatically, serially cut into the segments 134 that are of substantially the same longitudinal length as the blanks 128, and so that the segments 34 are respectively arranged in registration with (e.g., aligned with), and adhered to, the longitudinally extending, farthest away upper marginal surfaces of the blanks 128 (e.g., see FIG. 15). Similarly, operation of the systems of the manufacturing line 120 are coordinated (e.g., by way of the use of appropriate controller(s) and/or sensor(s)) to facilitate the proper timing of the passing of the blanks 128 from the supplying system 124 directly downstream to the edge protecting system 122, and optionally also from the edge protecting system directly to the downstream system 126.

Alternatively, the heat supplying apparatuses 158a, 158b, 158c may be omitted, and any other suitable features, such as those discussed above for the first embodiment, may be utilized for facilitating the mounting of the barrier segments 34 to the edges of the blanks 128. For example, adhesive applicators 46 may be used as discussed above for the first embodiment. In accordance with this alternative embodiment, the inner side of the barrier strip 136 would typically be selected for being compatible with the adhesive material. For instance, if the barrier strip 136 is a poly material, it may be desirable for the inner surface of the barrier strip that is to be adhered around the edge of the blank 128 to be corona, plasma, or otherwise “treated” for enhancing the manner in which the inner surface of the strip segments 134 accept the adhesive material supplied from the applicators 46. Regarding the outer surface of the barrier strip 136, it will typically comprise heat-sealable poly material, or the like, for being thermally fused to the inner barrier layers 206 to at least partially form the elongate bond(s) 224 of the lap seam 214. Alternatively, the one or more elongate bonds 224 may be formed through the use of any other suitable adhesive materials.

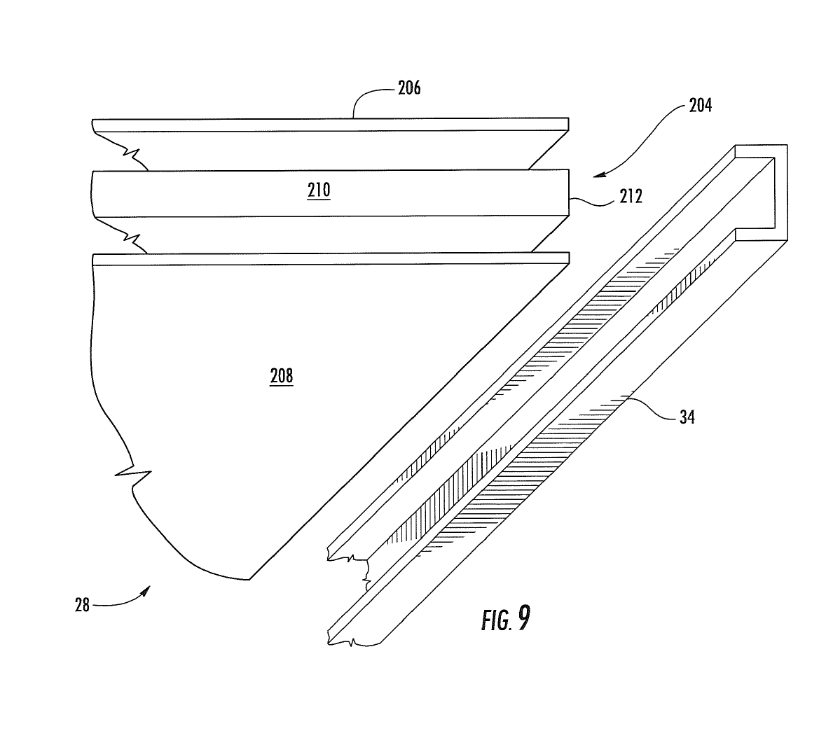

In another alternative to the second embodiment in which the heat supplying apparatuses 158a, 158b, 158c are omitted and only the upper adhesive applicator 46 is used, the upper adhesive applicator may optionally supply a slow-setting adhesive material (e.g., a water-base, cold adhesive) that would require a relatively large amount of “set time” between the initial application of a strip segment 134 to a blank 128 and the subsequent folding of the strip segment around the edge of the blank 128. In this alternative embodiment, the folding plow/diverter 162 may be moved farther downstream in the edge protecting system 122 or eliminated from it. For example, the folding plow/diverter 162 may be positioned downstream from the delivery conveyor 126. As the blanks 128 exit the delivery conveyor 126, they can be “de-shingled” (e.g., pulled one at a time from the shingled stack in a timed manner to re-establish spacing between each blank). After the blanks 128 are spaced out again, the plow/diverter 162 can be employed to fold-over and optionally also heat seal the previously unsecured marginal portions of the strip segments 134 to the respective surfaces of the blanks 128 to provide the configuration shown in FIGS. 7 and 8. More generally, the opposite marginal portions of the strip segments 134 may be mounted to the opposite marginal portions of the blanks 128 in any suitable manner, such as through the use of any suitable adhesive materials and techniques.

Various elements (e.g., systems) discussed with reference to the embodiments of this disclosure may be interchanged to create other embodiments of this disclosure. For example, in the manufacturing line 20 of the first embodiment, the edge protecting system 22 of the first embodiment may be replaced with the edge protecting system 122 of the second embodiment, and vice versa. The edge protecting system 122 of the second embodiment may be able to operate more quickly than the edge protecting system 22 of the first embodiment and/or the forming system 26 of the first embodiment. Nonetheless and for example, the operational speed of the edge protecting system 122 of the second embodiment may be adjusted (e.g., slowed down) to match the operational speed of the forming system 26 of the first embodiment. A wide variety of combinations, subcombinations, adjustments and operational speeds are within the scope of this disclosure. For example, a variety of suitable techniques for mounting (e.g., adhering) have been disclosed, and they may be substituted for one another accordingly.

Features of the above-discussed controller(s) of the first and second embodiments may be embodied in any suitable manner, such as in software, firmware and/or hardware modules. For example, the controller(s) may be in the form of one or more programmable logic controllers or computers (which may include appropriate input and output devices, a processor, memory, software modules, etc.) or any other suitable device(s) for controlling operations.

All directional references (e.g., inner, outer, further away, upper, lower, upward, downward, left, right, leftward, rightward, top, bottom, above, below, vertical, horizontal, clockwise, and counterclockwise) are used only for identification purposes to aid the reader's understanding of the various embodiments of this disclosure, and do not create limitations, particularly as to the position, orientation, or use of the invention unless specifically set forth in the claims.

The above examples are in no way intended to limit the scope of the present invention. It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A method of processing blanks comprising paperboard, the method comprising:
conveying the blanks in series, in a machine direction, wherein each blank comprises an edge that extends in the machine direction during the conveying, and opposite surfaces that extend to the edge; and
covering the edges of the blanks with respective elongate barrier strips, comprising
serially mounting the barrier strips respectively to the blanks during the conveying, comprising, for each blank and the respective barrier strip, mounting a first elongate portion of the barrier strip to a marginal portion of the first surface of the blank, so that a second elongate portion of the barrier strip protrudes outwardly past the edge of the blank, wherein each of the marginal portion of first surface of the blank and the first and second portions of the barrier strip extend along the edge of the blank; and
then folding the second elongate portion of the barrier strip around the edge of the blank, and mounting the second elongate portion of the barrier strip to a marginal portion of the second surface of the blank.

2. The method according to claim 1, comprising utilizing an adhesive backing of the barrier strip in both:
the mounting of the first elongate portion of the barrier strip, and
the mounting of the second elongate portion of the barrier strip.

3. The method according to claim 1, comprising heating the barrier strip for utilizing thermoplastic adhesive material of the barrier strip in both:
the mounting of the first elongate portion of the barrier strip, and
the mounting of the second elongate portion of the barrier strip.

4. The method according to claim 1, comprising applying adhesive material to the marginal portion of the first surface of the blank prior to the mounting of the first elongate portion of the barrier strip to the marginal portion of the first surface of the blank.

5. The method according to claim 1, comprising applying adhesive material to the marginal portion of the second surface of the blank prior to the mounting of the second elongate portion of the barrier strip to the marginal portion of the second surface of the blank.

6. The method according to claim 1, wherein both the folding of the second elongate portion of the barrier strip around the edge of the blank, and the mounting of the second elongate portion of the barrier strip, occur during the conveying of the blanks in series.

7. The method according to claim 1, comprising cutting the barrier strips from a roll, wherein for each blank and the respective barrier strip, the cutting of the barrier strip from the roll occurs prior to the mounting of the second elongate portion of the barrier strip to the marginal portion of the second surface of the blank.

8. The method according to claim 1, wherein the conveying of the blanks in series comprises conveying the blanks on a conveyor, and the method further comprises serially placing the blanks onto the conveyor at an upstream end of the conveyor.

9. The method according to claim 1, further comprising serially forming the blanks into constructs, wherein for each blank and the respective barrier strip:
the forming of the blank into the construct occurs after the mounting of the second elongate portion of the barrier strip to the marginal portion of the second surface of the blank; and
the forming of the blank into the construct comprises connecting opposite ends of the blank to one another to form a lap seam, so that the blank extends around an interior space of the construct and the ends of the blank respectively are inner and outer ends of the blank, and both the barrier strip and the edge of the blank that is covered by the barrier strip are positioned at the inner end of the blank.

10. The method according to claim 1, wherein for each blank and the respective barrier strip:
the edge of the blank comprises an edge of paperboard, and
the covering of the edge of the blank comprises covering the edge of the paperboard with the barrier strip.

11. The method according to claim 10, further comprising cutting the blank from a composite sheet comprising the paperboard and a barrier layer fixedly connected to and covering a surface of the paperboard, wherein the cutting of the blank from the composite sheet exposes the edge of the paperboard.

12. A system for processing blanks, the system comprising:
a conveyor for serially conveying the blanks in a machine direction, so that for each blank an edge of the blank extends in the machine direction while the blank is being conveyed by the conveyor; and
a strip applicator for serially applying the barrier strips respectively to the blanks while the blanks are being conveyed by the conveyor, wherein for each blank and the respective barrier strip, the strip applicator mounts a first elongate portion of the barrier strip to a marginal portion of the blank that extends along the edge of the blank, so that the barrier strip extends along the edge of the blank and a second elongate portion of the barrier strip protrudes outwardly past the edge of the blank.

13. The system according to claim 12, wherein each of the barrier strips comprises an adhesive backing.

14. The system according to claim 12, comprising an adhesive applicator positioned proximate or upstream from the strip applicator for serially applying adhesive material respectively to the marginal portions of the blanks that respectively extend along the edges of the blanks.

15. The system according to claim 12, comprising a heater, wherein:
each of the barrier strips comprises thermoplastic adhesive material; and
the heater is positioned proximate or upstream from the strip applicator for heating the marginal portions of the blanks that respectively extend along the edges of the blanks, for heating the thermoplastic adhesive material.

16. The system according to claim 12, comprising a heater, wherein:
the strip applicator is configured for drawing a strip of barrier material from a source and cutting the barrier strips from the strip of barrier material, and the strip of barrier material comprises thermoplastic adhesive material; and
the heater is positioned for heating the thermoplastic adhesive material.

17. The system according to claim 12, further comprising a secondary mounting apparatus positioned downstream from the strip applicator for further mounting the barrier strips respectively to the blanks, wherein for each blank and the respective barrier strip, the secondary mounting apparatus folds the second elongate portion of the barrier strip around the edge of the blank, and mounts the second elongate portion of the barrier strip to a second marginal portion of the blank.

18. The system according to claim 17, wherein the secondary mounting apparatus comprises a folding plow.

19. The system according to claim 17, comprising an adhesive applicator positioned proximate or upstream from the secondary mounting apparatus for serially applying adhesive material respectively to the second marginal portions of the blanks.

20. The system according to claim 17, comprising a heater, wherein:
each of the barrier strips comprises thermoplastic adhesive material;
the heater is positioned downstream from the strip applicator; and
the heater is positioned proximate or upstream from the secondary mounting apparatus for heating the thermoplastic adhesive material.

21. The system according to claim 17, further comprising a forming system positioned downstream from the secondary mounting apparatus, for forming the blanks into constructs, wherein for each blank and the respective barrier strip, the forming system is operative for connecting opposite ends of the blank to one another to form a lap seam, so that the blank extends around an interior space of the construct and the ends of the blank respectively are inner and outer ends of the blank, and both the barrier strip and the edge of the blank that is covered by the barrier strip are positioned at the inner end of the blank.

22. A system for processing blanks, the system comprising:
a conveyor for serially conveying the blanks in a downstream, so that for each blank an edge of blank extends in the machine direction while the blank is being conveyed by the conveyor;
an upstream mounting system positioned along the conveyor for serially mounting the barrier strips respectively to the blanks while the blanks are being conveyed by the conveyor, wherein for each blank and the respective barrier strip, the upstream mounting system mounts a first elongate portion of the barrier strip to a first marginal portion of the blank that extends along the edge of the blank, so that the barrier strip extends long the edge of the blank and a second elongate portion of the barrier strip protrudes outwardly past the edge of the blank; and
a downstream mounting system positioned along the conveyor for further mounting the barrier strips respectively to the blanks, wherein for each blank and the respective barrier strip, the secondary mounting apparatus folds the second elongate portion of the barrier strip around the edge of the blank, and mounts the second elongate portion of the barrier strip to a second marginal portion of the blank, and wherein the second marginal portion of the blank is opposite the first marginal portion of the blank.

23. The system according to claim 22, wherein the upstream mounting system comprises a strip applicator for applying the first elongate portion of the barrier strip to the first marginal portion of the blank.

24. The system according to claim 23, wherein the upstream mounting system further comprises at least one apparatus selected from the group consisting of an adhesive applicator and an adhesive activator.

25. The system according to claim 22, wherein the downstream mounting system comprises a folding plow for folding the second elongate portion of the barrier strip around the edge of the blank, and applying the second elongate portion of the barrier strip to the second marginal portion of the blank.

26. The system according to claim 25, wherein the downstream mounting system further comprises at least one apparatus selected from the group consisting of an adhesive applicator and an adhesive activator.
